(19) United States
(12) Patent Application Publication
(10) Pub. No.: US 2006/0113222 A1
(43) Pub. Date: Jun. 1, 2006

(54) Mounting apparatus for setting individual articles in a receptacle

(76) Inventors: Waldemar Kiener, Lauchheim (DE); Paul Abele, Aalen (DE)

Correspondence Address: M. Robert Kestenbaum, 11011 Bermuda Dunes NE, Albuquerque, NM, 87111, US

(21) Appl. No.: 11/088,354

(22) Filed: Mar. 23, 2005

(30) Foreign Application Priority Data
Mar. 23, 2004 (DE) 10 2004 014 601.2
Aug. 2, 2004 (DE) 10 2004 037 634.4

(51) Int. Cl. B07C 5/00; B65G 47/34

(52) U.S. Cl. 209/561; 198/475.1

(57) ABSTRACT

The invention relates to a mounting apparatus for setting individual articles in a receptacle, having a sorting unit which has a plurality of storage spaces for accommodating a respective article and cyclically feeds the storage spaces of the sorting unit to a removal position, having a gripping device which removes the article from a storage space arranged in a removal position and cyclically feeds it to the receptacle in a setting position, the receptacle being held by a fixing device when the article is being set in said receptacle, at least two sorting units being provided, which can be optionally assigned to a removal position, and that at least one fixing device, or one gripping device, matched to the article to be set is assigned to the removal position at least in accordance with the number of different sizes, shapes, or sizes and shapes, of an article to be set in the receptacle.

### BACKGROUND OF THE INVENTION

1. Field of Invention

The invention relates to a mounting apparatus for setting individual articles in a receptacle according to the preamble of claim 1.

2. Prior Art

Such mounting apparatuses are used, for example, in the jewelry industry. The mounting apparatus comprises a gripping device which removes gemstones, for example diamond-like glass stones, zirconia stones or other jewelry elements, from a removal position and feeds them in a setting position to a receptacle. This involves various types and sizes of chain, in particular cup chain. By means of a sorting unit which has a plurality of storage spaces, the articles are fed in a singularized manner to the removal position. During the setting of the articles, the receptacle is held by a fixing device, thereby providing for a defined position.

The articles are sifted into a sorting disk of a sorting unit via an auxiliary device. The period remaining for the sorting operation depends on a cycle time for setting the article in the respective receptacle. A sorting disk is briefly stationary at least during the removal of the article from the storage space. During this time, the article must be sifted into the storage space or the latter must be occupied by said article. The cycle time for the setting of the article is usually shorter than the requisite sifting time, and the cyclic advance of the sorting disk to the next position is adapted to the setting time in order to achieve short production times. As a result, there is the risk of individual storage spaces not being filled or occupied, which subsequently leads to malfunction or to defective parts during the setting. In addition, resetting to another size or type of article to be processed is very complicated.

### BRIEF SUMMARY OF THE INVENTION

The object of the invention is therefore to provide a mounting apparatus in which the production time of an article to be positioned in a receptacle is shortened and the production reliability is increased.

This object is achieved by the mounting apparatus according to the invention according to the features of claim 1. Further advantageous embodiments and developments are specified in the further dependent claims.

The mounting apparatus according to the invention enables articles to be fitted in a flexible manner in a respective receptacle provided for this purpose. The mounting machine permits mounting of articles in a receptacle or the setting of an article in a receptacle for different sizes, shapes or types of article. The provision of a fixing device, gripping device and sorting device adapted to the article and the receptacle creates a flexible mounting machine which can be used in a variable manner. For example, in the jewelry industry, jewelry chains are produced which have both identical receptacles and receptacles differing in size and type in a chain, into which receptacles stones of different size and color and shape are inserted. Due to this flexible configuration of the mounting machine, these requirements can be fulfilled.

According to an advantageous configuration of the invention, provision is made for the at least one sorting device, the at least one fixing device and/or the at least one gripping device to be positioned in each case on a transfer unit. These transfer units permit in each case exact positioning of the respectively required mounting devices in order to enable the article to be fitted or set in a receptacle in accordance with the size, shape and type of article. As a result, the mounting apparatus can be of modular construction by virtue of the fact that, for example, a module which accommodates a plurality of sorting units is provided, a module for accommodating different grippers for the gripping device is provided, and a module for accommodating different fixing devices is provided.

The transfer unit preferably designed as a module can be activated separately. As a result, the individual transfer units can in each case be activated in a specific manner in order to carry out the mounting task by means of the interaction. This can also provide for free and independent programming. In addition, this construction permits optimization of the process times by in each case the individual change times and activation times of the modules being matched to one another, so that short cycle times are made possible.

Provision is advantageously made for the transfer unit to be designed as a carousel with at least two sorting units. As a result, the sorting unit provided on a circular path can be successively fed to the removal position in a simple manner. The sorting units can be processed one after the other and can be transferred from a sorting position into a working position.

Alternatively, provision is made for the transfer units to be designed as a longitudinal transfer device with at least two sorting units. As a result, the individual sorting units can be transferred into the working position and sorting position by a linear movement, which can preferably be activated via a servo drive. The sorting units arranged on a carousel or a longitudinal transfer unit may also be optionally assigned to the removal position.

The at least one sorting unit is preferably provided on the transfer unit in an interchangeable manner. This can provide for simple exchange of the sorting units and adaptation to different sizes or shapes of articles to be set. A simple exchange of the widely varying sorting units can thus provide for rapid resetting. The different size and/or shape of the article to be set requires not only changed positioning of the storage spaces but also corresponding adaptation of a sorting mechanism, so that the advantageous configuration of the sorting unit as an interchangeable unit provides for rapid resetting and flexible use.

Furthermore, in order to achieve short resetting times, provision is advantageously made for at least one gripping head of the gripping device and at least one fixing element of the fixing device to be interchangeable via quick-release connections, such as, for example, screwed connections, clamping and/or tightening devices. This provides for adaptation to the new article to be set through short resetting times. The control of the gripping head and of the fixing device and also of the positioning of the sorting unit is preferably effected via a concerted control program which synchronizes the individual feed paths and speeds.

Provision is preferably made for the interchangeable unit to be provided as a turret interchangeable unit, in particular as a turret head. As a result, a predetermined number of different grippers and/or fixing receptacles can in each case be provided individually or jointly in a turret magazine. The access to the turret magazine permits short cycle times, so that rapid mounting is provided for.

Due to the advantageous configuration of the mounting apparatus with at least two sorting units, the cycle time for the mounting or for the setting of the article in a receptacle is uncoupled from the positioning of the article in a storage space of a sorting unit, or from the sifting of said article therein. As a result, on the one hand, the mounting speed can be maximized and, on the other hand, the sorting speed can be set to a maximum at which it is ensured that each storage space is filled with an article. As a result, depending on the individual article, the times for the sorting of the articles may comprise a multiple of the setting cycle times. By the exchange of a first sorting unit from a working position by at least one further sorting unit, which can be moved from a sorting position into a working position, these time differences are bridged, so that a maximum production rate is provided for. At the same time, the optimization of the sorting speed can ensure that each article is sifted in a protective manner without damage.

The sorting unit preferably has a sorting disk which contains a plurality of storage spaces on a circular periphery and sifts the articles into the storage spaces by means of an auxiliary device or a sorting mechanism. As a result, the storage spaces can be arranged in an endless manner relative to the removal position. The circular periphery depends on both the size of the articles and the intermediate distances or the spacing of the storage spaces, so that reliable gripping of the article with the gripping device is provided for.

The storage spaces of the sorting unit are advantageously formed by holes or recesses adapted to the article. These holes or recesses are provided in such a way that the articles are accommodated in the correct position by the sorting disk, so that the orientation for the further processing is also ensured at the same time as the arrangement of the article in the storage space.

Provision is advantageously made for the articles to be sifted into the storage spaces by an intermittent, continuous, discontinuous rotary movement or by a forward and return rotary movement of the sorting disk. These flexible variants for the sifting of the articles are made possible in particular on account of the uncoupling of the sifting time per storage space and the setting time for the article. As a result, even very complicated geometries or sensitive articles can be provided in the correct position in the storage spaces for a setting operation.

According to a further advantageous configuration of the invention, provision is made for each sorting device to be driven separately with a servomotor. As a result, the accelerations for the start-up and braking can be adapted as a function of the geometry of the article and of the storage space. It is ensured that the article remains in the storage space during the acceleration and the braking movement. At the same time, this makes it possible for the transfer unit to be designed as a module with at least two sorting units in such a way as to be completely uncoupled from a drive of the mounting device.

The sorting device advantageously has a sensor which monitors the filling of the storage spaces in the sorting unit. After the storage space has been checked, it can be established whether the article is in the storage space and whether the article is positioned correctly in the storage space. If one of the two preconditions has not been met, the sensor transmits a signal to a control system, as a result of which this storage space is not fed to a removal position but rather the latter is overridden. Alternatively, if a storage space is not occupied, provision may be made for the sorting disk to perform the sifting operation once or several times until the storage spaces are completely occupied. On account of at least two sorting units arranged on a transfer unit, this process control is made possible without affecting the production time.

According to a further preferred configuration of the invention, provision is made for the storage space which was positioned for the removal of the article in the removal position to be detected before the sorting unit is changed, and for this position or the following storage space provided with an article to be transferred into the removal position for removal of an article again. This enables the individual storage spaces to be processed without a gap. The change from the empty working space to the filled working space into the removal position may be effected both immediately after the removal of the article and until the sorting device is positioned again in a removal position at the latest. The process times can be additionally optimized as a result.

The mounting apparatus according to the invention is used in particular for setting glass stones, semiprecious stones, precious stones, other jewelry elements or individual parts in chains or cup chains. Such mounting machines work with very short cycle times, during which, for example, more than 80 stones per minute are set.

Due to the mounting machine according to the invention, a jewelry chain which has, for example, two green, two white and five yellow stones in this sequence, the green and the yellow stones, for example, additionally having different sizes, can thus be produced by a mounting machine with short cycle times. In this mounting machine, at least five sorting devices are preferably provided, and these sorting devices accommodate the green, white and yellow stones and also the respective two different sizes of the green and yellow stones. In addition, at least two fixing devices and, if required, at least two different gripping devices are provided. In some cases, it is also possible for a gripping device to take hold of different sizes of article, so that a change is dispensed with. By the direct activation of the sorting devices, fixing devices and gripping devices, the respective change can be made directly by a control system. The modular construction provides for flexible resetting to further fitting and setting tasks.

### BRIEF DESCRIPTION OF THE DRAWINGS

The invention and further advantageous embodiments and developments of the same are described and explained below in more detail with reference to the examples shown in the drawings. The features to be gathered from the description and the drawings may be used individually on their own or a plurality thereof may be used in any desired combination according to the invention. In the drawings:

FIG. 1 shows a schematic sectional illustration of a mounting apparatus according to the invention,

FIG. 2 shows a schematic plan view of a mounting apparatus according to FIG. 1,

FIG. 3 shows a schematically enlarged sectional illustration of a gripping device in a removal position of the mounting apparatus according to FIG. 1,

FIG. 4 shows a schematic plan view of an alternative embodiment of the mounting apparatus according to FIG. 1, and

FIG. 5 shows a schematic sectional illustration of a sorting unit as an interchangeable part.

### DETAILED DESCRIPTION OF THE INVENTION

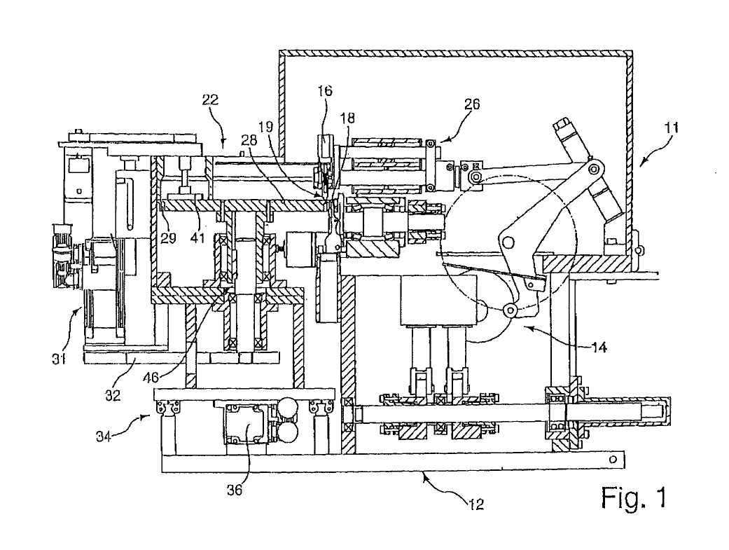

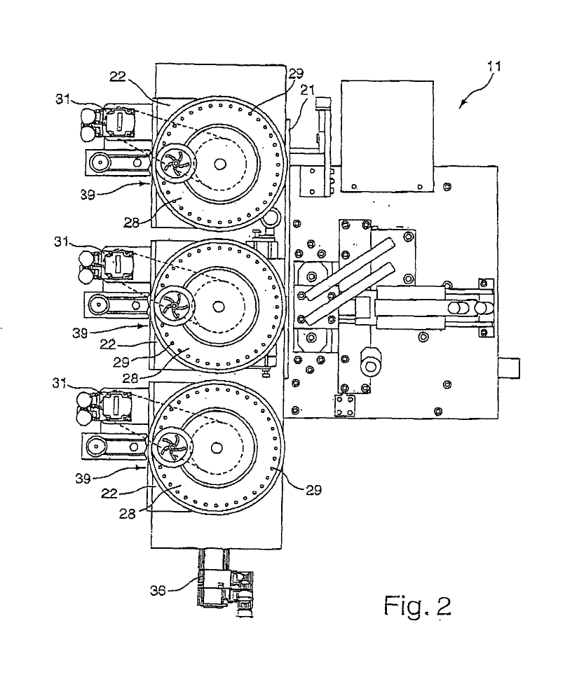

A mounting apparatus 11 according to the invention is shown in FIGS. 1 and 2. Provided on a base frame 12 is at least one drive unit 14 which drives a gripping device 16 and a fixing device 18. The gripping device 16 and the fixing device 18 are assigned to a removal position 19, in which an article 21 is removed from a sorting unit 22 and fed to a receptacle 24 held by the fixing device 18 in order to set the article 21 in the receptacle 24. During the setting operation, the gripping device 16 is transferred from the removal position 19 into a setting position (not shown in any more detail) via a guide 26. After the article 21 has been set in the receptacle 24, the receptacle 24 is advanced cyclically to the next position in order to accommodate the following article 21 by means of the following receptacle 24. Conveying elements are provided for this purpose in order to carry out a step-by-step cyclic advance. The stroke movement of the gripping device 16 for carrying out a working cycle and the step-by-step conveying of the receptacle 24 and fixing of the receptacle 24 by the fixing device 18 for the setting operation are synchronized, so that short cycle times are achieved for the setting operation.

The sorting unit 22 comprises a sorting disk 28, on which a plurality of storage spaces 29 for accommodating the articles 21 are provided. A servomotor 31 drives the sorting disk 28 in a rotatable manner via a toothed belt, a V-belt, a chain or the like.

Assigned to a mounting unit of the mounting apparatus 11, which at least comprises one gripping device 16 and one fixing device 18, is a transfer unit 34. This transfer unit 34 accommodates at least two sorting units 22. According to the exemplary embodiments in FIGS. 1 and 2, the transfer unit 34 is designed as a longitudinal transfer unit which is activated via a servo drive 36. As a result, the sorting unit 22 can be transferred from a working position 38 into a sorting position 39. In the working position 38, a storage space 29 of the sorting disk 28 is arranged in the removal position 19. By cyclical rotation of the sorting disk 28 as a function of the working cycle of the gripping device 16, the storage spaces 29 are successively processed in the working position 38.

The articles 21 are sifted in the sorting position 39. This refers to the correct positioning of an article 21 in a storage space 29. By means of the servomotor 31 for the sorting disk 28, these servomotors 31 each being separated from one another, the rotary movement of the sorting disk 28 for the sifting can be activated differently from the cycle time for setting the articles 21.

In the sorting position 39, sifting of the articles 21 into the storage spaces 29 is carried out by an auxiliary device 41 or by a sorting mechanism, such as a rotating baffle for example.

An article-specific speed of the sorting disk 28 and/or of the auxiliary device 41 can be set means of the servomotor 31 assigned to the sorting disk 28 in order to set the rotary speed in such a way that an optimum sorting speed is achieved. On account of at least one sorting unit 22 outside the working position 38, this sorting speed is independent of the cycle time of the gripping device 16, so that the mounting speed is maximized.

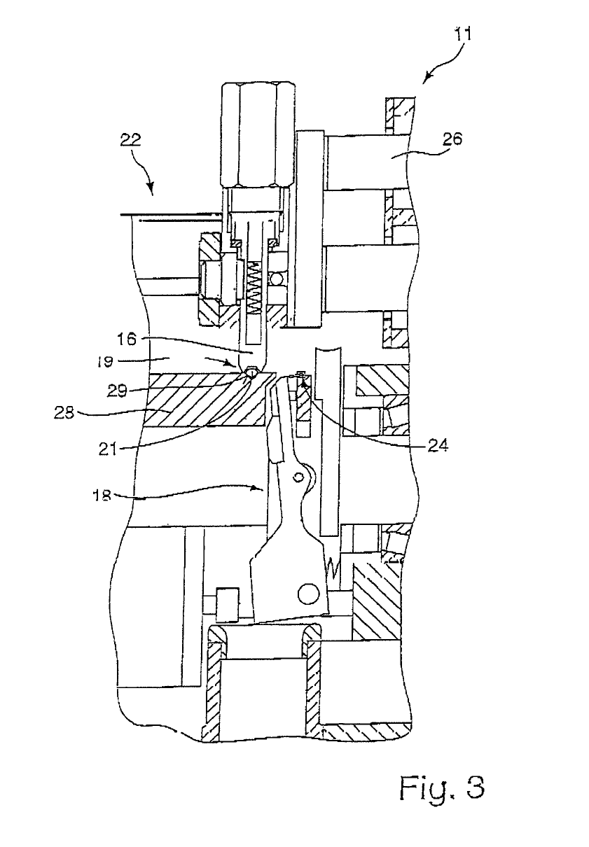

The removal position 19 is shown schematically enlarged in FIG. 3. In this position, the storage space 29 of the sorting disk 28, the gripping device 16, the fixing device 18 and the receptacle 24 are positioned relative to one another. The fixing device 18 is arranged in such a way for fixing the receptacle 24 that a free space is formed, so that the sorting units 22 can be alternately transferred from a working position 38 into a sorting position 39 and vice versa.

Due to the sorting arrangement 22 being arranged temporarily in the sorting position 39, this enables the sifting to be effected independently of the cyclical sequence of the working stroke. As a result, for example, a continuous or discontinuous sifting operation, intermittent sifting or an alternating forward and return movement of the sorting disk 28 may be effected. Furthermore, after the initial sifting operation, a control pass may be effected, during which, for example, at least one sensor checks the storage spaces 29 to determine whether each is occupied and or whether the article 21 is positioned correctly in the storage space 29. If an error should be indicated, the sifting is repeated at least for this storage space 29.

The mounting apparatus 11 is intended, for example, for the jewelry industry for sorting diamond-like glass stones, zirconia stones and other semiprecious stones, precious stones, other jewelry elements or individual parts. These are set in chains or cup chains.

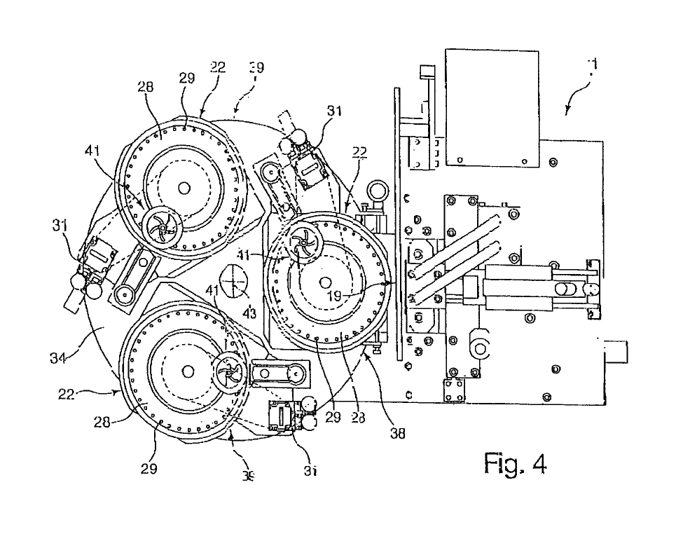

An alternative configuration of a transfer unit 34 with sorting units 22 is shown in FIG. 4. The transfer unit 34 is designed, for example, as a carousel and accommodates three sorting units 22, which can be transferred one after the other from a sorting position 39 into a working position 38. Sequences described in FIGS. 1 to 3 for setting the articles 21 in the receptacle 24 take place in an analogous manner. The transfer unit 34 is preferably driven in one pass direction. As a result, the time required to fill the storage spaces 29 in the case of, for example, three sorting units 22 on a transfer unit 34 can correspond to the time required for the gripping device 16 to process two sorting units 22. This analogously applies to the corresponding number of sorting units 22 on a carousel.

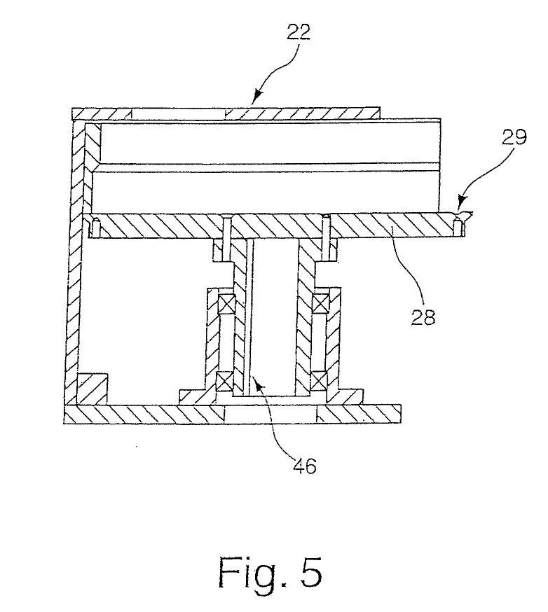

To increase the flexibility of the mounting apparatus 11, provision is advantageously made for the sorting unit 22 to be interchangeably positioned on the transfer unit 34. For example, according to FIG. 5, the sorting unit 22 is designed as an interchangeable part. A shaft/hub connection 46, for example, provides for a rapidly interchangeable rotary drive. The sorting disk 28 is adapted to the article 21 with regard to the size, configuration and positioning of the storage space 29 and the number of storage spaces 29. The configuration of the sorting unit 22 as an interchangeable part increases the flexibility and makes possible a modular construction of the mounting apparatus 11.

Furthermore, provision is made for the fixing device 18 to be provided as a modular unit. For example, the retaining head of the fixing device for fixing the receptacle 24 during the mounting can be provided on a transfer unit in order to permit rapid exchange and rapid adaptation. This may be provided for by a turret head for example. Furthermore, change magazines may be used. This analogously applies to the gripping device 16. The flexibility can be increased by the modular construction in the machine.

Provision may be advantageously made, for example when setting stones in a cup chain in which one size and/or type of the article many times, in comparison with a further type and/or size of the article, for at least two sorting devices to be provided for the article to be set many times and for only one sorting device to be provided for the article to be set only in a small quantity. As a result, the cycle times can again be reduced, so that, after the processing of the first sorting unit, the further sorting unit can be fed to the removal device, and the first sorting unit permits 100% filling of the storage spaces with articles outside the cycle time for filling the receptacle.

The mounting apparatus 11 according to the figures shown may be arranged both in a horizontal orientation and so as to be inclined at an acute angle. As a result, the sorting can be assisted by the individual articles sliding automatically into the marginal region in which the storage spaces 29 are arranged. The auxiliary device 41 or a sorting mechanism is preferably positioned at or close to the deepest point in the inclined arrangement.

The articles 21 provided for mounting may be of any shape, size, type and configuration. This mounting apparatus 11 can be adapted to may different applications.

The features described above are each essential to the invention on their own and may be combined in any desired manner.

1. A mounting apparatus for setting individual articles in a receptacle, having a sorting unit which has a plurality of storage spaces for accommodating a respective article and cyclically feeds the storage spaces of the sorting unit to a removal position, having a gripping device which removes the article from a storage space arranged in a removal position and cyclically feeds it to the receptacle in a setting position, the receptacle being held by a fixing device when the article is being set in said receptacle, wherein at least two sorting units are provided, which can be optionally assigned to a removal position, and wherein at least one fixing device, or one gripping device, matched to the article to be set is assigned to the removal position at least in accordance with the number of different sizes, shapes, or sizes and shapes, of an article to be set in the receptacle.

2. The mounting apparatus as claimed in claim 1, wherein at least one first sorting device, one fixing device or one gripping device are in each case positioned on a transfer unit.

3. The mounting apparatus as claimed in claim 1, wherein each transfer unit designed as a module can be activated separately.

4. The mounting apparatus as claimed in claim 2, wherein the transfer unit is designed as a carousel with at least two sorting units.

5. The mounting apparatus as claimed in claim 2, wherein the transfer units is designed as a longitudinal transfer device with at least two sorting units.

6. The mounting apparatus as claimed in claim 1, wherein the at least one sorting unit is interchangeably accommodated in a transfer unit as an interchangeable part.

7. The mounting apparatus as claimed in claim 1, wherein the transfer unit having at least one gripping head of the gripping device and at least one fixing element of the fixing device is designed as an interchangeable unit.

8. The mounting apparatus as claimed in claim 7, wherein the interchangeable unit is provided as a turret interchangeable unit.

9. The mounting apparatus as claimed in claim 1, wherein, after the storage spaces have been processed, the sorting unit can be moved from a working position into a sorting position and at least one further sorting unit whose storage spaces are filled with articles can be moved from a sorting position into the working position.

10. The mounting apparatus as claimed in claim 1, wherein the sorting unit has a sorting disk which contains a plurality of storage spaces on a circular periphery, an auxiliary device which sifts the articles into the storage spaces being assigned to the latter.

11. The mounting apparatus as claimed in claim 1, wherein the articles are sifted into the storage spaces by an intermittent, continuous, discontinuous rotary movement or by a forward and return rotary movement of the sorting disk.

12. The mounting apparatus as claimed in claim 1, wherein the storage spaces are formed by holes or recesses adapted to the article.

13. The mounting apparatus as claimed in claim 1, wherein each sorting unit is in each case driven by at least one servomotor.

14. The mounting apparatus as claimed in claim 1, wherein at least one sensor is provided for monitoring the filling of the storage spaces in the sorting unit.

15. The mounting apparatus as claimed in claim 1, wherein the storage space which was positioned for the removal of the article in the removal position is detected before the sorting unit is changed, and wherein this position or the following storage space provided with the article is transferred into the removal position for removal of an article again after the sorting unit is changed.

16. The mounting apparatus as claimed in claim 1, wherein the articles are glass stones, zirconia stones, semiprecious stones or precious stones.

17. The mounting apparatus as claimed in claim 1, wherein the receptacle is of band- or chain-shaped design for accommodating a plurality of articles.

18. The mounting apparatus as claimed in claim 17, wherein the receptacle is a cup chain.
